(19) United States
(12) Patent Application Publication
(10) Pub. No.: US 2026/0023695 A1
(43) Pub. Date: Jan. 22, 2026

(54) COUPLING PROCESSING UNITS TO DATA BUSES IN MEMORY

(71) Applicant: Micron Technology, Inc., Boise, ID (US)

(72) Inventors: Glen E. Hush, Boise, ID (US); Peter L. Brown, Eagle, ID (US); Troy A. Manning, Meridian, ID (US)

(21) Appl. No.: 19/268,234

(22) Filed: Jul. 14, 2025

Related U.S. Application Data
(60) Provisional application No. 63/672,127, filed on Jul. 16, 2024.

(51) Int. Cl. G06F 13/16

(52) U.S. Cl. CPC G06F 13/16; G06F 2213/40

(57) ABSTRACT

Coupling processing units to data buses in memory is described herein. A data bus coupled to an array of memory cells can receive first data. A processing unit (PU) can be coupled to the data bus. The PU can receive the first data from the data bus. The PU can perform a plurality of operations utilizing the first data to generate second data. The PU can provide the second data to the data bus to store the second data in the array of memory cells.

### PRIORITY INFORMATION

This application claims the benefits of U.S. Provisional Application No. 63/672,127, filed on Jul. 16, 2025, the contents of which are incorporated herein by reference.

### TECHNICAL FIELD

The present disclosure relates generally to memory, and more particularly to apparatuses and methods associated with coupling processing units to data buses in memory.

### BACKGROUND

Memory devices are typically provided as internal, semiconductor, integrated circuits in computers or other electronic devices. There are many different types of memory including volatile and non-volatile memory. Volatile memory can require power to maintain its data and includes random-access memory (RAM), dynamic random access memory (DRAM), and synchronous dynamic random access memory (SDRAM), among others. Non-volatile memory can provide persistent data by retaining stored data when not powered and can include NAND flash memory, NOR flash memory, read only memory (ROM), Electrically Erasable Programmable ROM (EEPROM), Erasable Programmable ROM (EPROM), and resistance variable memory such as phase change random access memory (PCRAM), resistive random access memory (RRAM), and magnetoresistive random access memory (MRAM), among others.

Memory is also utilized as volatile and non-volatile data storage for a wide range of electronic applications. Non-volatile memory may be used in, for example, personal computers, portable memory sticks, digital cameras, cellular telephones, portable music players such as MP3 players, movie players, and other electronic devices. Memory cells can be arranged into arrays, with the arrays being used in memory devices.

### BRIEF DESCRIPTION OF THE DRAWINGS

FIG. 1 is a block diagram of an apparatus in the form of a computing system including a memory device in accordance with a number of embodiments of the present disclosure.

FIG. 2A is a block diagram illustrating a coupling of a processing unit to an output data bus in accordance with a number of embodiments of the present disclosure.

FIG. 2B is a block diagram illustrating a coupling of a processing unit to an input data bus in accordance with a number of embodiments of the present disclosure.

FIG. 3A is a block diagram illustrating a coupling of a processing unit to an input data bus and an output data bus in accordance with a number of embodiments of the present disclosure.

FIG. 3B is a block diagram illustrating a coupling of a processing unit to an input data bus and an output data bus in accordance with a number of embodiments of the present disclosure.

FIG. 4 illustrates an example flow diagram of a method for coupling a processing unit to data buses in memory in accordance with a number of embodiments of the present disclosure.

FIG. 5 illustrates an example machine of a computer system within which a set of instructions, for causing the machine to perform any one or more of the methodologies discussed herein, can be executed.

### DETAILED DESCRIPTION

The present disclosure includes apparatuses and methods associated with coupling processing units to data buses in memory. The memory can include a data bus coupled to an array of memory cells. The data bus can receive first data. The memory can also include a processing unit (PU) coupled to the data bus. The PU can receive the first data from the data bus, perform a plurality of operations utilizing the first data to generate second data, and provide the second data to the data bus to store the second data in the array of memory cells.

In previous approaches, the PU of a memory is coupled to both an input data bus and an output data bus to receive data and provide data. For example, the PU may receive data and provide data through the input data bus. The PU may also receive data and provide data through the output data bus. Configuring the PU to receive data from the input data bus and the output data bus and to output data to the input data bus and the output data bus can allow for greater flexibility but may also be costly to implement.

In order to address these and other deficiencies of previous approaches, embodiments of the present disclosure configure the PU to receive data from one (e.g., only one) of the input data bus or the output data bus and provide (e.g., output) data to one (e.g., only one) of the input data bus or the output data bus. For example, the PU can be coupled to the input data bus or the output data bus, but not both, to receive data. The PU can also be coupled to the input data bus or the output data bus, but not both, to provide (e.g., output). Limiting the PU to receiving data from one of the input data bus or the output data bus and providing data to one of the input data bus or the output data bus can reduce the cost of implementing the PU as compared to coupling the PU to both the input data bus and the output data bus to both receive data and provide data. Limiting the PU to receiving data from one of the input data bus or the output data bus and providing data to one of the input data bus or the output data bus can also reduce the area of the die used to implement the PU.

Such a PU can receive data and can perform a number of operations on the data to generate different data (e.g., output data). The PU can be used to implement an artificial neural network (ANN). In various examples, multiple PU's can be used to implement an ANN. The data received by the PU can be weights and/or inputs to an ANN, for example.

As used herein, ANNs can provide learning by forming probability weight associations between an input and an output. The probability weight associations can be provided by a plurality of nodes that comprise the ANN. The nodes together with weights, biases, and activation functions can be used to generate an output of the ANN based on the input to the ANN. A plurality of nodes of the ANN can be grouped to form layers of the ANN.

As used herein, artificial intelligence (AI) refers to the ability to improve an apparatus through “learning” such as by storing patterns and/or examples which can be utilized to take actions at a later time. Deep learning refers to a device's ability to learn from data provided as examples. Deep learning can be a subset of AI. Neural networks, among other types of networks, can be classified as deep learning. Improving the efficiency at which ANNs are executed can improve a function of a memory device executing the ANN and the function of the device in which the memory device is implemented. For example, improving the latency, power consumption, and/or throughput of the memory device implementing the ANN can cause an improvement to the latency, power consumption, and/or throughput of a memory system.

As used herein, “a number of” something can refer to one or more of such things. For example, a number of memory devices can refer to one or more memory devices. A “plurality” of something intends two or more. Additionally, designators such as “N,” as used herein, particularly with respect to reference numerals in the drawings, indicates that a number of the particular feature so designated can be included with a number of embodiments of the present disclosure.

The figures herein follow a numbering convention in which the first digit or digits correspond to the drawing figure number and the remaining digits identify an element or component in the drawing. Similar elements or components between different figures may be identified by the use of similar digits. As will be appreciated, elements shown in the various embodiments herein can be added, exchanged, and/or eliminated so as to provide a number of additional embodiments of the present disclosure. In addition, the proportion and the relative scale of the elements provided in the figures are intended to illustrate various embodiments of the present disclosure and are not to be used in a limiting sense.

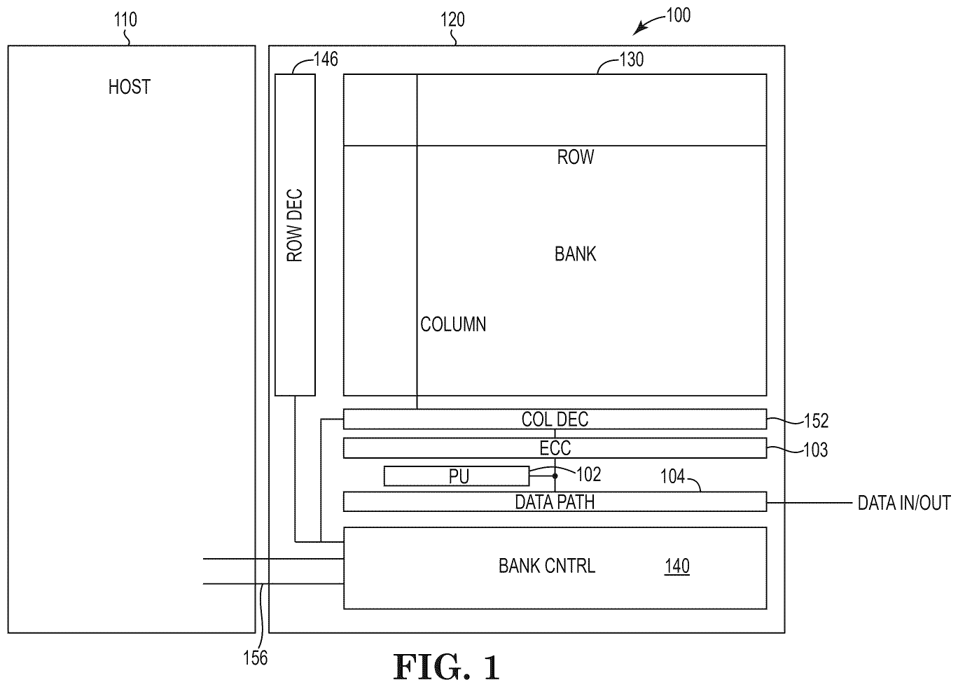

FIG. 1 is a block diagram of an apparatus in the form of a computing system 100 including a memory device 120 in accordance with a number of embodiments of the present disclosure. As used herein, a memory device 120, a bank 130 of memory cells, also referred to as a memory array 130, host 110, a PU 102, and/or the bank controller 140 (e.g., the controller 140) might also be separately considered an “apparatus.”

In this example, system 100 includes a host 110 coupled to memory device 120 via an interface 156. The computing system 100 can be a personal laptop computer, a desktop computer, a digital camera, a mobile telephone, a memory card reader, or an Internet-of-Things (IoT) enabled device, among various other types of systems. Host 110 can include a number of processing resources (e.g., one or more processors, microprocessors, or some other type of controlling circuitry) capable of accessing memory 120. The system 100 can include separate integrated circuits, or both the host 110 and the memory device 120 can be on the same integrated circuit. For example, the host 110 may be a system controller of a memory system comprising multiple memory devices 120, with the system controller 110 providing access to the respective memory devices 120 by another processing resource such as a central processing unit (CPU).

In the example shown in FIG. 1, the host 110 is responsible for executing an operating system (OS) and/or various applications that can be loaded thereto (e.g., from memory device 120 via controller 140). The host 110 can provide access commands and/or security mode initialization commands to a memory device via the interface 156.

For clarity, the system 100 has been simplified to focus on features with particular relevance to the present disclosure. The memory array 130 can be a DRAM array, SRAM array, STT RAM array, PCRAM array, TRAM array, RRAM array, NAND flash array, and/or NOR flash array, for instance. The array 130 can comprise memory cells arranged in rows coupled by access lines (which may be referred to herein as word lines or select lines) and columns coupled by sense lines (which may be referred to herein as digit lines or data lines). Although a single array 130 is shown in FIG. 1, embodiments are not so limited. For instance, memory device 120 may include a number of arrays 130 (e.g., a number of banks 130 of DRAM cells).

The memory device 120 includes address circuitry to latch address signals provided over the interface 156. The interface 156 can include, for example, a physical interface employing a suitable protocol (e.g., a data bus, an address bus, and a command bus, or a combined data/address/command bus). Such protocol may be custom or proprietary, or the interface 156 may employ a standardized protocol, such as Peripheral Component Interconnect Express (PCIe), Gen-Z, CCIX, or the like. Address signals are received and decoded by a row decoder 146 and a column decoder 152 to access the memory array 130. Data can be read from memory array 130 by sensing voltage and/or current changes on the sense lines using sensing circuitry. The sensing circuitry can comprise, for example, sense amplifiers that can read and latch a page (e.g., row) of data from the memory array 130. The I/O circuitry can be used for bi-directional data communication with host 110 over the interface 156. Read/write circuitry is used to write data to the memory array 130 or read data from the memory array 130.

Controller 140 decodes signals provided by the host 110. These signals can include chip enable signals, write enable signals, and address latch signals that are used to control operations performed on the memory array 130, including data read, data write, and data erase operations. In various embodiments, the controller 140 is responsible for executing instructions from the host 110. The controller 140 can comprise a state machine, a sequencer, and/or some other type of control circuitry, which may be implemented in the form of hardware, firmware, or software, or any combination of the three.

In various instances, the controller 140 can receive signals provided by the host 110 including signals requesting operations to be performed by the PU 102. As used herein, the PU 102 can include hardware and/or firmware for performing operations, such as, for example, multiplication operations, using data provided by the memory array 130 or the host 110.

In various examples, error correction code (ECC) circuitry 103 can receive data from the memory array 130. The ECC circuitry 103 can perform error correction operations to correct errors in data sensed from the memory array 130. The PU 102 can be coupled to the ECC circuitry 103. The PU 102 can perform a plurality of operations on data received from the ECC circuitry 103. The PU 102 can provide an output to the data path 104. The data path 104 can provide data to the interface 156 including a plurality of data pins that couple the memory device 120 to the computing system 100. The ECC circuitry 103 can be coupled to the data path 104 via an input data bus and an output data bus. The input data bus can be used to provide data to the memory array 130. For example, the input data bus can provide data from the host 110 to the memory array 130. The output data bus can be used to provide data from the memory array 130. For example, the output data bus can provide data from the memory array 130 to the host 110. The PU 102 can be coupled to the output data bus and/or the input data bus.

In various instances, the controller 140 (e.g., the bank controller) can provide signals to the PU 102 to cause the PU 102 to receive data from the input data bus or the output data bus and/or to provide data to the input data bus or the output data bus.

For example, the controller 140 can provide signals to the PU 102 to indicate that the input data bus and/or the output data bus are available for utilization. The PU 102 can receive data from the input data bus or the output data bus. The PU 102 can perform a number of operations using the received data to generate different data (e.g., output data). The PU 102 can provide the output data to the input data bus or the output data bus.

If the PU 102 is configured to receive data from the input data bus and provide output data to the output data bus, then the PU 102 may not receive data directly from the memory array 130 and may not provide data directly to the memory array 130. As used herein, providing data directly or receiving data directly includes receiving or providing data via a first data bus and not a second data bus. Providing data indirectly or receiving data indirectly includes receiving or providing data via a first data bus and a second data bus. For example, data can be provided from the PU 102 to the memory array 130 via an output data bus and an input data bus. If the PU 102 is configured to receive data from the output data bus and provide output data to the input data bus, then the PU 102 may receive data directly from the memory array 130 and may provide data directly to the memory 130.

Providing data directly to the memory array and receiving data directly from the memory array can indicate that data is received and provided without the utilization of the data path 104 and/or the data pins of the memory device. As used herein, the data pins physically couple the memory device 120 to the host 110. The pins of the memory device 120 are a physical interface that enables communication between the memory device 120 and the host 110. The interface coupling the memory device 120 and the host 110 can form a physical connection through metal connections. The pins of the interface can be composed of metals such as copper, nickel, and/or gold, among other types of metals. The pins can include top pins and bottom pins. The top pins and the bottom pins can include pins formed on either side of a circuit board and are not intended to limit the orientation of the pins on the memory device 120. The memory device 120 receives signals through the pins. For example, the memory device 120 can receive, via the interface 156, commands, addresses, and/or data, among other signals, through the pins.

If the PU 102 is configured to receive data from the input data bus and provide output data to the input data bus, then the PU 102 may not receive data directly from the memory array 130 but may provide data directly to the memory array 130. If the PU 102 is configured to receive data from the output data bus and provide output data to the output data bus, then the PU 102 may receive data directly from the memory array 130 and may not provide data directly to the memory 130.

If the PU 102 is not configured to provide data directly to the memory array 130, then the PU 102 can utilize the output data path 104 to provide data from the output data bus to the input data bus to cause the output data of the PU 102 to be stored in the memory array 130. If the PU 102 is not configured to receive data directly from the memory array 130, then the PU 102 can utilize the output data path 104 to provide data from the output data bus to the input data bus to cause the data stored in the memory array 130 to be provided to the PU 102.

In various examples, the PU 102 can be coupled to the input data bus and the output data bus utilizing control circuitry. The control circuitry coupling the PU 102 to the input data bus and the output data bus can include one or more multiplexors (MUXs). The MUXs can divert data from the input data path or the output data path to the PU 102. The MUXs can also insert data into the input data path or the output data path from the PU 102.

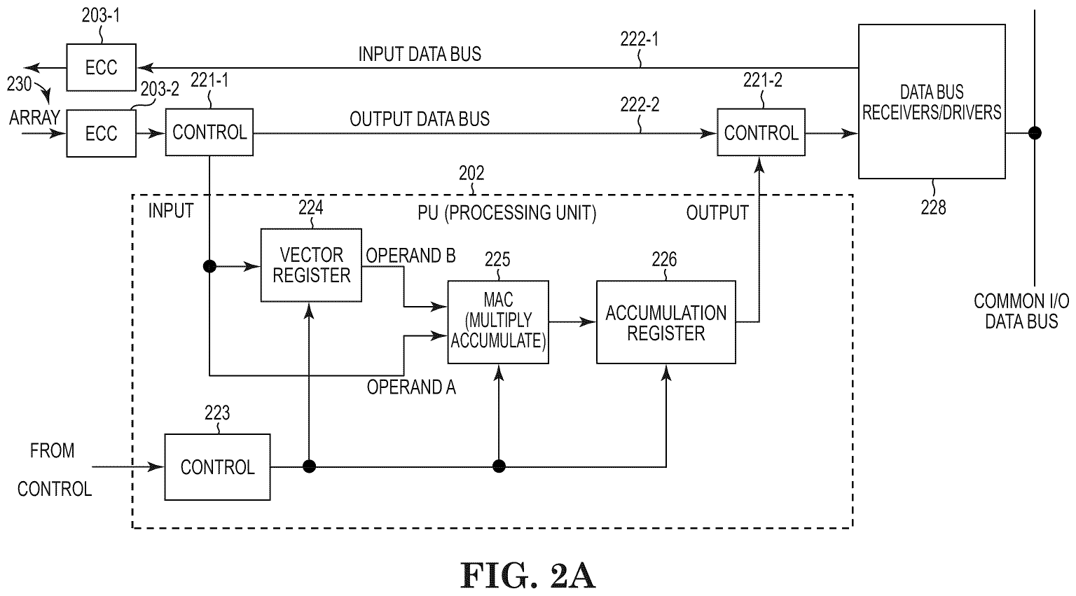

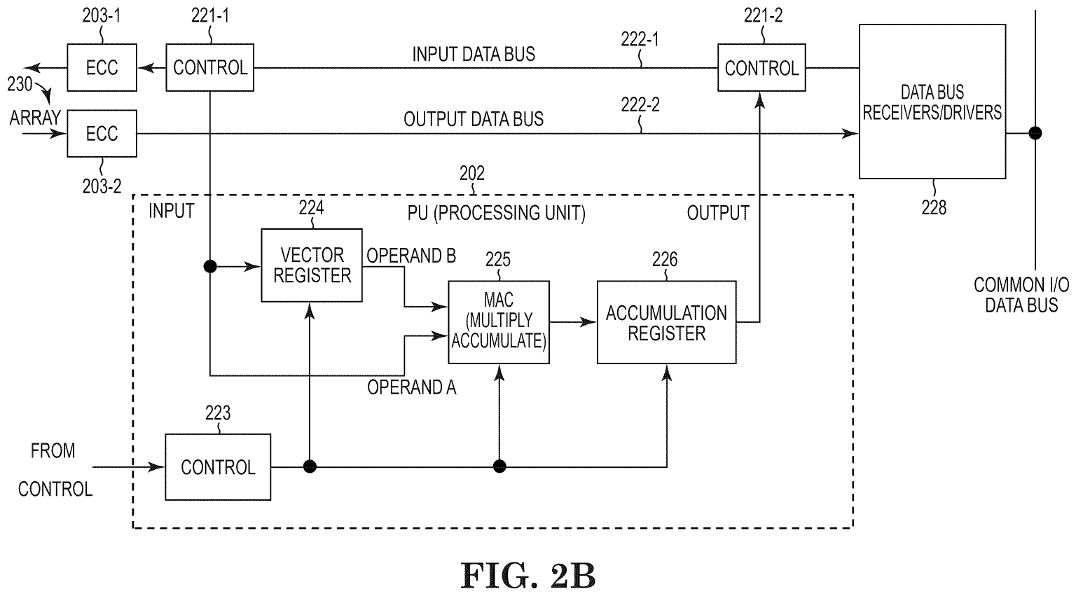

FIG. 2A is a block diagram illustrating a coupling of a PU 202 to an output data bus 222-2 in accordance with a number of embodiments of the present disclosure. FIG. 2A includes an input data bus 222-1 and the output data bus 222-2 that couple an array 230 of memory cells to a common input/output (I/O) data bus. The memory array 230 is analogous to memory array 130 of FIG. 1. As used herein the input data bus 222-1 and the output data bus 222-2 can be local I/O data buses that provide data from the array 130 to the common I/O data bus. The common I/O data bus can also be referred to as a global data bus. The global data bus can receive data from multiple banks of memory cells and can provide the data to a plurality of pins of the memory device. FIG. 2A also includes the PU 202 and the data bus receivers and drivers 228. The PU 202 is analogous to the PU 102 of FIG. 1. The data bus receives and drivers 228 can receive signals from the common I/O data bus and can drive signals to the common I/O data bus.

The PU 202 includes a vector register 224, MAC units 225, a controller 223, and an accumulator 226. The vector register 224 can be, for example, a shift register configured to shift through data values of an input stored in the shift register and provide the data values to the MAC units 225.

The controller 223 can receive control signals from the controller 140 of FIG. 1 via a control bus, which can couple the controller 140 to the controller 223. The PU 202 can receive signals indicative of data from the output data bus 222-2 and provide signals indicative of data via the output data bus 222-2. Input signal received from the output data bus 222-2 can be stored in the vector register 224 (e.g., as illustrated for operand B) or can be provided directly to the MAC units 225 (e.g., as illustrated for operand A), bypassing the vector register 224. The operand B can be provided by the vector register 224 to the MAC units 225 without requiring that the operand B be provided to the PU 202 multiple times.

The input signals can provide inputs which represent data values from a matrix and/or a vector. The input signals (e.g., operand A and operand B) can be provided to the MAC units 225. The MAC units 225 can perform operations using the operand A and the operand B. The outputs (e.g., output data) of the MAC units 225 can be accumulated in the accumulation registers 226.

The controller 223 (e.g., PU controller 223) can be coupled to the vector registers 224, the MAC units 225, and the accumulation registers 226. The controller 223 can cause input data to be stored in the vector registers 224. The controller 223 can cause a plurality of operations to be performed by the MAC units 225 using the input data (e.g., operand A and operand B). The controller 223 can cause the outputs of the MAC units 225 to be accumulated and stored in the accumulation registers 226. The controller 223 can cause the output data to be provided from the accumulation registers 226 to the output data bus 222-2.

The output data bus 222-2 can receive the input data (e.g., a first data) from the array 130 of memory cells. The output data bus 222-2 can provide the output data (e.g., second data) stored in the accumulation register 226 to the data pins of the memory device. The data pins can couple the memory device to the computing system that includes the host. The output data bus 222-2 can provide the output data to the array 230 via the input data bus 222-1. For example, a bus controller can cause data provided by the output data bus 222-2 to be provided to the input data bus 222-1 without providing the output data to the data pins. The input data bus 222-1 can provide the output data to the memory array 230. In various examples, the output data can be provided to the common I/O data bus (e.g., global I/O bus) via the data bus receivers and drivers 228 prior to providing the output data from the common I/O bus to the input data bus 222-1. The array 230 can store the output data. In other examples, the output data can be provided from the common I/O data bus to the host via the data pins.

In various instances, control circuitry 221-1, 221-2 can couple the PU 202 to the output data bus 222-2. For instance, the control circuitry 221-1 can route input data from the output data bus 222-2 to the PU 202. The control circuitry 221-2 can route the output data from the PU 202 to the output data bus 222-2.

In various examples, the control circuitry 221-1, 221-2 can include one or more MUXs. For example, the control circuitry 221-1 can include a 1:2 MUX. The 1:2 MUX can receive the input data (e.g., first data) from the array 230 of memory cells. The 1:2 MUX can provide the input data to the PU 202 or the data pins.

The control circuitry 221-2 can include a 2:1 MUX. The 2:1 MUX can receive the output data (e.g., second data) from the PU 202 or different data from the array 230 of memory cells. The 2:1 MUX can provide the output data or the different data to the data pins. For example, the 2:1 MUX can couple the output data bus 222-2 to the PU 202 such that the PU 202 outputs data to the output data bus 222-2 via the control circuitry 221-2. The control circuitry 221-2 can receive the output data (e.g., second data) from the PU or different data from the array 230 via the 2:1 MUX. The control circuitry 221-2 can provide the output data to the data pins.

The control circuitry 221-1 can be configured to input data to the PU 202 from the output data bus 222-2 and not the input data bus 222-1. The control circuitry 221-2 can be configured to output data to the output data bus 222-2 and not the input data bus 222-1. The coupling of the PU 202 to receive data from the output data bus 222-2 can utilize less die area than coupling the PU 202 to receive data from the input data bus 222-1 and the output data bus 222-2. The coupling of the PU 202 to provide data to the output data bus 222-2 can utilize less die area than coupling the PU 202 to provide data to the input data bus 222-1 and the output data bus 222-2. Reducing the die area can reduce the cost of implementing the PU in the memory device.

In various examples, a bank controller 140 of FIG. 1 can provide a signal to the PU controller 223 to indicate that the input data is available on the output data bus 222-2. The PU controller 223, responsive to receipt of the signals from the bank controller, can configure the control circuitry 221-1 to provide the input data to the PU 202 from the output data bus 222-2.

The bank controller can also provide a signal to the PU controller 223 to indicate that the output data bus 222-2 is available. The PU controller 223, responsive to receipt of the signals from the bank controller, can provide signals to the control circuitry 221-2 to cause the control circuitry 221-2 to route the output data from the PU 202 to the output data bus 222-2.

Responsive to the PU 202 receiving the input data from the array 230 of memory cells, the control circuitry 221-1 can be configured to provide data to the data pins and not the PU 202. Responsive to the array 230 of memory cells receiving the output data from the PU 202, the control circuitry 221-2 can be configured to provide data from the array 230 of memory cells to the data pins and not the PU 202. The controller 223 can configure the control circuitry 221-1 and the control circuitry 221-2.

FIG. 2B is a block diagram illustrating a coupling of a PU 202 to an input data bus 222-1 in accordance with a number of embodiments of the present disclosure. FIG. 2B includes the input data bus 222-1 and an output data bus 222-2 that couple an array 230 of memory cells to a common input/output (I/O) data bus. The memory array 230 is analogous to memory array 130 of FIG. 1. FIG. 2B also includes the PU 202 and the data bus receivers and drivers 228. The PU 202 is analogous to the PU 102 of FIG. 1.

The PU 202 includes a vector register 224, MAC units 225, a controller 223, and an accumulator 226, as described in relation to FIG. 2A. The PU 202 can receive signals indicative of input data from the input data bus 222-1 and provide signals indicative of output data via the input data bus 222-1. Input signals received from the input data bus 222-1 can be stored in the vector register 224 (e.g., as illustrated for operand B) or can be provided directly to the MAC units 225 (e.g., as illustrated for operand A), bypassing the vector register 224. The operand B can be provided from the vector register 224 to the MAC units 225 without requiring that the operand B be provided to the PU 202 multiple times.

The controller 223 (e.g., PU controller 223) can be coupled to the vector registers 224, the MAC units 225, and the accumulation registers 226. The controller 223 can cause input data to be stored in the vector registers 224. The controller 223 can cause a plurality of operations to be performed by the MAC units 225 using the input data (e.g., operand A and operand B). The controller 223 can cause the outputs of the MAC units 225 to be accumulated and stored in the accumulation registers 226. The controller 223 can cause the output data to be provided from the accumulation registers 226 to the input data bus 222-1.

The input data bus 222-1 can receive the input data (e.g., a first data) from the data pins of the memory device. The input data bus 222-1 can provide the output data (e.g., second data) stored in the accumulation register 226 to array 230 of memory cells. The input data bus 222-1 can provide the output data directly to the array 230. The array 230 can store the output data. The output data can be read from the array 230 to provide the output data to a host via the data pins, for example.

In various instances, control circuitry 221-1, 221-2 can couple the PU 202 to the input data bus 222-1. For instance, the control circuitry 221-1 can route input data from the input data bus 222-1 to the PU 202. The input data can be received from a host via data pins and the input data bus 222-1. The control circuitry 221-2 can route the output data from the PU 202 to the input data bus 222-2.

In various examples, the control circuitry 221-1, 221-2 can include one or more MUXs. For example, the control circuitry 221-1 can include a 1:2 MUX. The 1:2 MUX can receive the input data (e.g., first data) from the data pins. The 1:2 MUX can provide the input data to the PU 202 or the array 230 of memory cells.

The control circuitry 221-2 can include a 2:1 MUX. The 2:1 MUX can receive the output data (e.g., second data) from the PU 202 or different data from the data pins. The 2:1 MUX can provide the output data or the different data to the array 230 of memory cells. For example, the 2:1 MUX can couple the input data bus 222-1 to the PU 202 such that the PU 202 outputs data to the input data bus 222-1 via the control circuitry 221-2. The control circuitry 221-2 can receive the output data (e.g., second data) from the PU or different data from the data pins. The control circuitry 221-2 can provide the output data to the array 230 of memory cells.

The control circuitry 221-1 can be configured to input data to the PU 202 from the input data bus 222-1 and not the output data bus 222-2. The control circuitry 221-2 can be configured to output data to the input data bus 222-1 and not the output data bus 222-2. The coupling of the PU 202 to receive data from the input data bus 222-1 can utilize less die area than coupling the PU 202 to receive data from the input data bus 222-1 and the output data bus 222-2. The coupling of the PU 202 to provide data to the input data bus 222-1 can utilize less die area than coupling the PU 202 to provide data to the input data bus 222-1 and the output data bus 222-2. Reducing the die area can reduce the cost of implementing the PU in the memory device.

In various examples, a bank controller 140 of FIG. 1 can provide a signal to the PU controller 223 to indicate that the input data bus 222-1 carries input data. The PU controller 223, responsive to receipt of the signals from the bank controller, can provide signals to the control circuitry 221-1 to cause the control circuitry 221-1 to route the input data from the input data bus 222-2 to the PU 202.

The bank controller can also provide a signal to the PU controller 223 to indicate that the input data bus 222-1 is available. The PU controller 223, responsive to receipt of the signals from the bank controller, can provide signals to the control circuitry 221-2 to cause the control circuitry 221-2 to route the output data from the PU 202 to the input data bus 222-1.

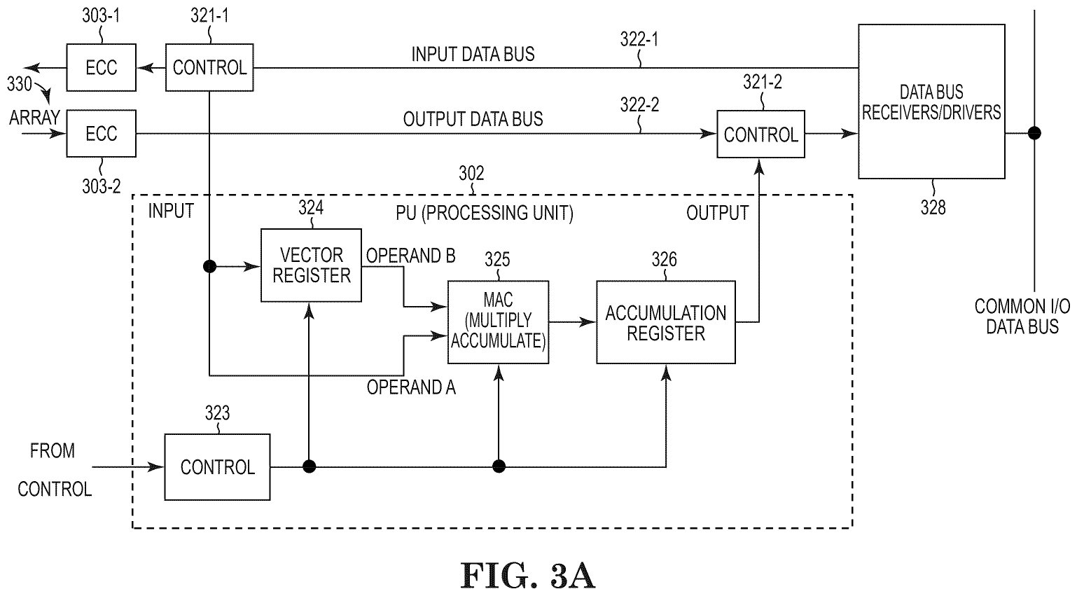

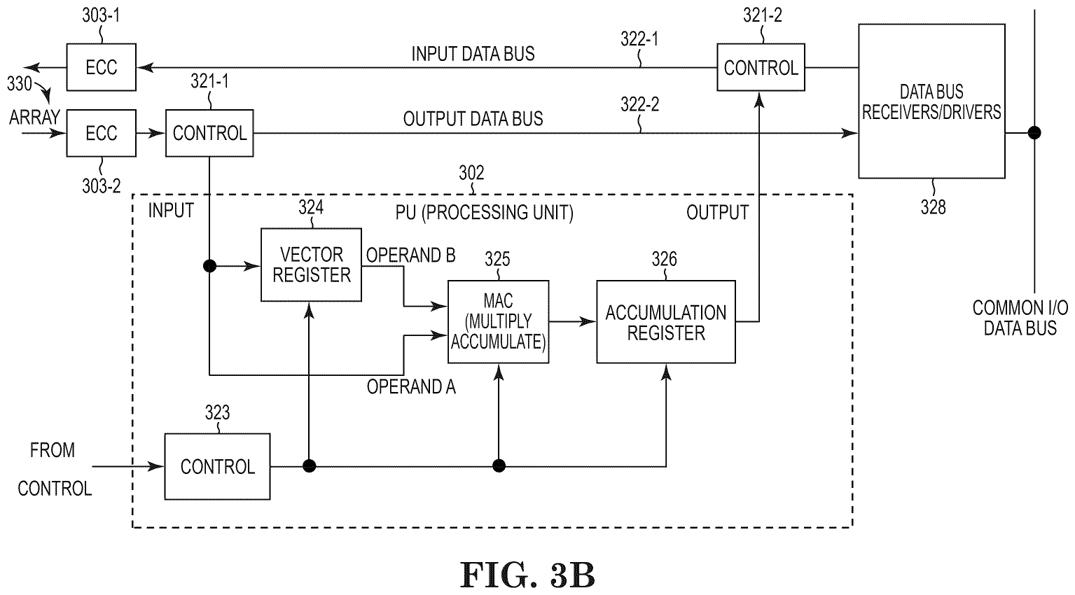

FIG. 3A is a block diagram illustrating a coupling of a PU 302 to an input data bus 322-1 and an output data bus 322-2 in accordance with a number of embodiments of the present disclosure. The input data bus 322-1 and the output data bus 322-2 can couple an array 330 of memory cells to a common input/output (I/O) data bus. The memory array 330 is analogous to memory arrays 130 and 230 of FIG. 1, FIG. 2A and FIG. 2B, respectively. FIG. 3A also includes the PU 302 and the data bus receivers and drivers 328. The PU 302 is analogous to the PUs 102, 202 of FIG. 1, FIG. 2A, and FIG. 2B, respectively.

The PU 302 includes a vector register 324, MAC units 325, a controller 323, and an accumulator 326, as described in relation to the vector register 224, the MAC units 225, the controller 223, and the accumulator 226 of FIGS. 2A and 2B. The PU 302 can receive signals indicative of input data from the input data bus 322-1 and provide signals indicative of output data via the output data bus 322-2. Input signals received from the input data bus 322-1 can be stored in the vector register 324 (e.g., as illustrated for operand B) or can be provided directly to the MAC units 325 (e.g., as illustrated for operand A), bypassing the vector register 324. The operand B can be provided from the vector register 324 to the MAC units 325 without requiring that the operand B be provided to the PU 302 multiple times.

The controller 323 (e.g., the PU controller 323) can be coupled to the vector registers 324, the MAC units 325, and the accumulation registers 326. The controller 323 can cause input data to be stored in the vector registers 324. The controller 323 can cause a plurality of operations to be performed by the MAC units 325 using the input data (e.g., operand A and operand B). The controller 323 can cause the outputs of the MAC units 325 to be accumulated and stored in the accumulation registers 326. The controller 323 can cause the output data to be provided from the accumulation registers 326 to the output data bus 322-2.

The input data bus 322-1 can receive the input data (e.g., a first data) from the data pins. The output data bus 322-2 can provide the output data (e.g., second data) stored in the accumulation register 326 to the data pins. The output data bus 322-2 can provide the output data indirectly to the array 330. The array 330 can store the output data. The output data bus 322-2 can also provide the output data directly to the data pins to provide the output data to a host.

In various instances, control circuitry 321-1 can couple the PU 302 to the input data bus 322-1. The control circuitry 321-2 can couple the PU 302 to the output data bus 322-2. For instance, the control circuitry 321-1 can route input data from the input data bus 322-1 to the PU 302. The input data can be received from the data pins and provided to the input data bus 322-1. The control circuitry 321-2 can route the output data from the PU 302 to the output data bus 322-2.

In various examples, the control circuitry 321-1, 321-2 can include one or more MUXs. For example, the control circuitry 321-1 can include a 1:2 MUX. The 1:2 MUX can receive the input data (e.g., first data) from the data pins. The 1:2 MUX can provide the input data to the PU 302 or the array 330 of memory cells.

The control circuitry 321-2 can include a 2:1 MUX. The 2:1 MUX can receive the output data (e.g., second data) from the PU 302 or different data from the array 330 of memory cells. The 2:1 MUX can provide the output data or the different data to the data pins via the common I/O data bus. For example, the 2:1 MUX can couple the output data bus 322-2 to the PU 302 such that the PU 302 outputs data to the output data bus 322-2 via the control circuitry 321-2. The control circuitry 321-2 can receive the output data (e.g., second data) from the PU or different data from the array 330 of memory cells. The control circuitry 321-2 can provide the output data to the data pins via the command I/O data bus and the data bus receivers and drivers 328.

The control circuitry 321-1 can be configured to input data to the PU 302 from the input data bus 322-1 and not the output data bus 322-2. The control circuitry 321-2 can be configured to output data to the output data bus 322-2 and not the input data bus 322-1. The coupling of the PU 302 to receive data from the input data bus 322-1 can utilize less die area than coupling the PU 302 to receive data from the input data bus 322-1 and the output data bus 322-2. The coupling of the PU 302 to provide data to the output data bus 322-2 can utilize less die area than coupling the PU 302 to provide data to the input data bus 322-1 and the output data bus 322-2. Reducing the die area can reduce the cost of implementing the PU 302 in the memory device.

In various examples, a bank controller 140 of FIG. 1 can provide a signal to the PU controller 323 to indicate that the input data bus 322-1 carries input data. The PU controller 323, responsive to receipt of the signals from the bank controller, can provide signals to the control circuitry 321-1 to cause the control circuitry 321-1 to route the input data from the input data bus 322-1 to the PU 302.

The bank controller can also provide signals to the PU controller 323 to indicate that the output data bus 322-2 is available. The PU controller 323, responsive to receipt of the signals from the bank controller, can provide signals to the control circuitry 321-2 to cause the control circuitry 321-2 to route the output data from the PU 302 to the output data bus 322-2.

FIG. 3B is a block diagram illustrating a coupling of a PU 302 to an input data bus 322-1 and an output data bus 322-2 in accordance with a number of embodiments of the present disclosure. The input data bus 322-1 and the output data bus 322-2 can couple an array 330 of memory cells to a common input/output (I/O) data bus. The memory array 330 is analogous to memory arrays 130 and 230 of FIG. 1, FIG. 2A and FIG. 2B, respectively. FIG. 3B also includes the PU 302 and the data bus receivers and drivers 328. The PU 302 is analogous to the PUs 102, 202 of FIG. 1, FIG. 2A, and FIG. 2B, respectively.

The PU 302 includes a vector register 324, MAC units 325, a controller 323, and an accumulator 326, as described in relation to the vector register 224, the MAC units 225, the controller 223, and the accumulator 226 of FIGS. 2A and 2B. The PU 302 can receive signals indicative of input data from the output data bus 322-2 and provide signals indicative of output data via the input data bus 322-1. Input signals received from the output data bus 322-2 can be stored in the vector register 324 (e.g., as illustrated for operand B) or can be provided directly to the MAC units 325 (e.g., as illustrated for operand A), bypassing the vector register 324. The operand B can be provided from the vector register 324 to the MAC units 325 without requiring that the operand B be provided to the PU 302 multiple times.

The controller 323 (e.g., the PU controller 323) can be coupled to the vector registers 324, the MAC units 325, and the accumulation registers 326. The controller 323 can cause input data to be stored in the vector registers 324. The controller 323 can cause a plurality of operations to be performed by the MAC units 325 using the input data (e.g., operand A and operand B). The controller 323 can cause the outputs of the MAC units 325 to be accumulated and stored in the accumulation registers 326. The controller 323 can cause the output data to be provided from the accumulation registers 326 to the input data bus 322-1.

The output data bus 322-2 can receive the input data (e.g., a first data) from the array 330 of memory cells. The input data bus 322-1 can provide the output data (e.g., second data) stored in the accumulation register 326 to the array 330 of memory cells. The input data bus 322-1 can provide the output data directly to the array 330 and indirectly to the data pin. The array 330 can store the output data. The output data stored in the array 330 of memory cells can be sensed and provided to the data pins via the output data bus 322-2. The output data bus 322-2 can provide the input data directly to the PU 302 and different data to the data pins to provide the different data to a host.

In various instances, control circuitry 321-1 can couple the PU 302 to the output data bus 322-2. The control circuitry 321-2 can couple the PU 302 to the input data bus 322-1. For instance, the control circuitry 321-1 can route input data from the output data bus 322-2 to the PU 302. The input data can be sensed from the array 330 of memory cells and provided to the output data bus 322-2. The control circuitry 321-2 can route the output data from the PU 302 to the input data bus 322-1.

In various examples, the control circuitry 321-1, 321-2 can include one or more MUXs. For example, the control circuitry 321-1 can include a 1:2 MUX. The 1:2 MUX can receive the input data (e.g., first data) from the array 330 of memory cells. The 1:2 MUX can provide the input data to the PU 302 or the data pins.

The control circuitry 321-2 can include a 2:1 MUX. The 2:1 MUX can receive the output data (e.g., second data) from the PU 302 or different data from the data pins. The 2:1 MUX can provide the output data or the different data to the array 330 of memory cells. For example, the 2:1 MUX can couple the input data bus 322-1 to the PU 302 such that the PU 302 outputs data to the input data bus 322-1 via the control circuitry 321-2. The control circuitry 321-2 can receive the output data (e.g., second data) from the PU or different data from data pins. The control circuitry 321-2 can provide the output data to array 330 of memory cells.

The control circuitry 321-1 can be configured to input data to the PU 302 from the output data bus 322-2 and not the input data bus 322-1. The control circuitry 321-2 can be configured to output data to the input data bus 322-1 and not the output data bus 322-2. The coupling of the PU 302 to receive data from the output data bus 322-2 can utilize less die area than coupling the PU 302 to receive data from the input data bus 322-1 and the output data bus 322-2. The coupling of the PU 302 to provide data to the input data bus 322-2 can utilize less die area than coupling the PU 302 to provide data to the input data bus 322-1 and the output data bus 322-2. Reducing the die area can reduce the cost of implementing the PU 302 in the memory device.

In various examples, a bank controller 140 of FIG. 1 can provide a signal to the PU controller 323 to indicate that the output data bus 322-2 carries input data. The PU controller 323 can receive an indication that the input data is available on the output data bus 322-2. The PU controller 323, responsive to receipt of the signals from the bank controller, can provide signals to the control circuitry 321-1 to cause the control circuitry 321-1 to route the input data from the output data bus 322-2 to the PU 302. For example, the PU controller 323 can configure the control circuitry 321-1 to provide the input data from the output data bus 322-2.

The bank controller can also provide signals to the PU controller 323 to indicate that the input data bus 322-1 is available. The PU controller 323, responsive to receipt of the signals from the bank controller, can provide signals to the control circuitry 321-2 to cause the control circuitry 321-2 to route the output data from the PU 202 to the input data bus 322-1. For example, the PU controller 323 can configure the control circuitry 321-2 to provide the output data to the array 330 of memory cells via the input data bus 322-1.

Responsive to the PU 302 receiving the input data from the array 330 of memory cells, the control circuitry 321-1 can be configured to provide data to the data pins instead of providing data to the PU 302. The controller 323 can configure the control circuitry 321-1. Responsive to PU 302 providing output data to the array 330 of memory cells via the control circuitry 321-2 and the input data bus 322-1, the control circuitry 321-2 can be configured to provide data to the array 330 of memory cells instead of providing data from the PU 302. The controller 323 can configure the control circuitry 321-2.

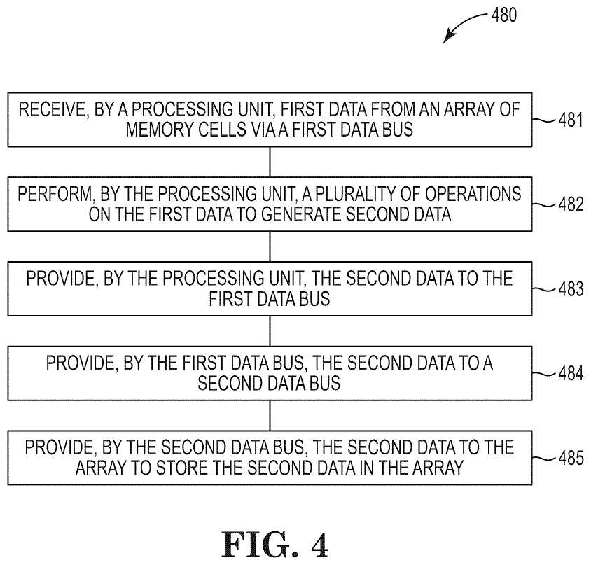

FIG. 4 illustrates an example flow diagram of a method 480 for coupling a processing unit to data buses in memory in accordance with a number of embodiments of the present disclosure. The method can be performed by a memory device of a computing system, such as, for instance memory device 120 of computing system 100 previously described in connection with FIG. 1.

At 481, a PU can receive first data from an array of memory cells via a first data bus. The PU can be analogous to the PUs 102, 202, 302 of FIG. 1, FIGS. 2A and 2B, and FIGS. 3A and 3B, respectively. The first data can be input data. The first data bus can be an output data bus such as output data buses 222-2 and 322-2 of FIGS. 2A, 2B, 3A, and 3B, respectively. The array of memory cells can be the arrays 130, 230, 330 of FIGS. 2A, 2B, 3A, and 3B, respectively. The first data can be provided directly from the array of memory cells to the PU without utilizing an input data bus.

At 482, the PU can perform a plurality of operations on the first data to generate second data. The plurality of operations can include multiplication operations and accumulation operations, for example. The plurality of operations can be performed to implement an ANN, for example.

At 483, the PU can provide the second data to the first data bus. The second data can be output data. The output data can be a result of performing the plurality of operations. The PU can be coupled to the first data bus and not to the second data bus. The second data bus can be input data buses 222-1, 322-1 of FIGS. 2A, 2B, 3A, and 3B.

At 484, the first data bus can provide the second data to the second data bus. The first data bus can provide the second data to the second data bus to cause the second data to be stored in the array of memory cells. The PU may not provide the second data to the second data bus because the PU is not coupled to the second data bus. The PU can indirectly provide the second data to the second data bus by causing the first data bus to provide the second data to the second data bus.

At 485, the second data bus can provide the second data to the array of memory cells to store the second data in the array. A bank controller can control the transfer of data from the first data bus to the second data bus and can control the storage of the second data in the array of memory cells.

The PU can receive an indication that the first data is available on the first data bus. Data may continuously pass through the first data bus. The PU can access the first data responsive to receiving the indication. For example, the PU can configure a first control circuitry to provide the first data to the PU from the first data bus.

After receiving the first data, the PU can receive a different indication that the first data bus is available. The first data bus can be available for providing data through the first data bus. The PU can receive the indications from a bank controller. The PU can configure the second control circuitry to provide the second data to first data bus. The first control circuitry can couple the PU to the first data bus for receive the first data at the PU. The second control circuitry can couple the PU to the first data bus for providing the second data to the first data bus.

The PU can configure the first control circuitry to provide data to the data pins responsive to the PU receiving the first data from the array. That is, after the PU configures the first control circuitry to provide the first data to the PU, the PU can configure the first control circuitry to provide future received data to the data pins and not the PU. The PU can configure the second control circuitry to provide data to the data pins responsive to the array of memory cells receiving the second data.

In various examples, a data bus can be coupled to an array of memory cells. The data bus can receive first data. The data bus can receive the first data from the array of memory cells, for example. A PU can be coupled to the data bus. The PU can receive the first data from the data bus and can perform a plurality of operations utilizing the first data to generate second data. The PU can provide the second data to the data bus to store the second data in the array of memory cells.

The data bus can be an input data bus. The input data bus can receive the first data from a host. The input data bus can provide the second data to the array of memory cells.

The data bus can also be an output data bus. The output data bus can receive the first data from the array of memory cells. The output data bus can provide the second data to data pins of the apparatus. The output data bus can provide the second data to the array of memory cells via an input data bus of the apparatus.

In other examples, a first data bus can be coupled to an array of memory cells. A second data bus can be coupled to the array of memory cells. A PU can be coupled to the first data bus and the second data bus. The PU can receive first data from the first data bus and not the second data bus. The PU can perform a plurality of operations utilizing the first data to generate second data. The PU can provide the second data to the second data bus and not the first data bus.

The first data bus can be an input data bus and the second data bus can be an output data bus. The input data bus can provide the first data to the array of memory cells or the PU. The output data bus can provide the second data received from the PU or different data received from the array of memory cells to data pins.

The first data bus can also be an output data bus and the second data bus can be an input data bus. The input data bus can provide the second data or different data to the array of memory cells. The output data bus can provide first data received from the array of memory cells to data pins or the PU.

The PU can be coupled to a first control circuitry and a second control circuitry. The first control circuitry and the second control circuitry can couple the first data bus and the second data bus to the PU. The first control circuitry couples the first data bus to the PU and comprises a 1:2 MUX. The 1:2 MUX can receive the first data from the array of memory cells, can provide the first data to the PU or data pins. The second control circuitry can couple the second data bus to the PU. The second control circuitry can comprise a 2:1 MUX. The 2:1 MUX can receive the second data from the PU or different data from the data pins and can provide the different data or the second data to the array.

In other examples, the first control circuitry couples the first data bus to the PU and comprises a 2:1 MUX. The 2:1 MUX can receive the first data from data pins and provide the first data to the PU or the array. The second control circuitry coupled the second data bus to the PU and can comprises a 2:1 MUX. The 2:1 MUX can receive the second data from the PU or different data from the array and can provide the second data or the different data to the data pins. The PU comprises a controller (e.g., PU controller). The PU controller can configure the first control circuitry and the second control circuitry. For example, the PU controller can provide a signal to the first control circuitry to cause the first control circuitry to provide data to the PU or to provide data to the array of memory cells or the pins. The PU controller can provide a signal to the second control circuitry to cause the second control circuitry to provide data from the PU to the array of memory cells or the data pins or to provide data from the array of memory cells to the data pins or from the data pins to the array of memory cells.

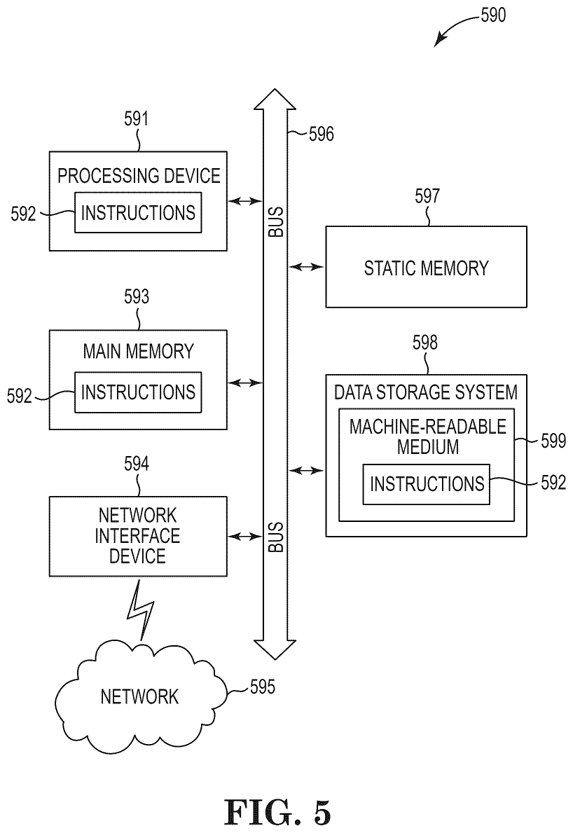

FIG. 5 illustrates an example machine of a computer system 590 within which a set of instructions, for causing the machine to perform any one or more of the methodologies discussed herein, can be executed. In some embodiments, the computer system 590 can correspond to a host system (e.g., the host 110 of FIG. 1) that includes, is coupled to, or utilizes a memory system (e.g., the memory device 120 of FIG. 1) or can be used to perform the operations of the controller (e.g., the controller 140 and/or the PU 102 of FIG. 1). In alternative embodiments, the machine can be connected (e.g., networked) to other machines in a LAN, an intranet, an extranet, and/or the Internet. The machine can operate in the capacity of a server or a client machine in client-server network environment, as a peer machine in a peer-to-peer (or distributed) network environment, or as a server or a client machine in a cloud computing infrastructure or environment.

The machine can be a personal computer (PC), a tablet PC, a set-top box (STB), a Personal Digital Assistant (PDA), a cellular telephone, a web appliance, a server, a network router, a switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 590 includes a processing device 591, a main memory 593 (e.g., read-only memory (ROM), flash memory, dynamic random access memory (DRAM) such as synchronous DRAM (SDRAM) or Rambus DRAM (RDRAM), etc.), a static memory 597 (e.g., flash memory, static random access memory (SRAM), etc.), and a data storage system 598, which communicate with each other via a bus 596.

Processing device 591 represents one or more general-purpose processing devices such as a microprocessor, a central processing unit, or the like. More particularly, the processing device can be a complex instruction set computing (CISC) microprocessor, reduced instruction set computing (RISC) microprocessor, very long instruction word (VLIW) microprocessor, or a processor implementing other instruction sets, or processors implementing a combination of instruction sets. Processing device 591 can also be one or more special-purpose processing devices such as an application specific integrated circuit (ASIC), a field programmable gate array (FPGA), a digital signal processor (DSP), network processor, or the like. The processing device 591 is configured to execute instructions 592 for performing the operations and steps discussed herein. The computer system 590 can further include a network interface device 594 to communicate over the network 595.

The data storage system 598 can include a machine-readable storage medium 599 (also known as a computer-readable medium) on which is stored one or more sets of instructions 592 or software embodying any one or more of the methodologies or functions described herein. The instructions 592 can also reside, completely or at least partially, within the main memory 593 and/or within the processing device 591 during execution thereof by the computer system 590, the main memory 593 and the processing device 591 also constituting machine-readable storage media.

In one embodiment, the instructions 592 include instructions to implement functionality corresponding to the PU 102 of FIG. 1. While the machine-readable storage medium 599 is shown in an example embodiment to be a single medium, the term “machine-readable storage medium” should be taken to include a single medium or multiple media that store the one or more sets of instructions. The term “machine-readable storage medium” shall also be taken to include any medium that is capable of storing or encoding a set of instructions for execution by the machine and that cause the machine to perform any one or more of the methodologies of the present disclosure. The term “machine-readable storage medium” shall accordingly be taken to include, but not be limited to, solid-state memories, optical media, and magnetic media.

Although specific embodiments have been illustrated and described herein, those of ordinary skill in the art will appreciate that an arrangement calculated to achieve the same results can be substituted for the specific embodiments shown. This disclosure is intended to cover adaptations or variations of various embodiments of the present disclosure. It is to be understood that the above description has been made in an illustrative fashion, and not a restrictive one. Combinations of the above embodiments, and other embodiments not specifically described herein will be apparent to those of skill in the art upon reviewing the above description. The scope of the various embodiments of the present disclosure includes other applications in which the above structures and methods are used. Therefore, the scope of various embodiments of the present disclosure should be determined with reference to the appended claims, along with the full range of equivalents to which such claims are entitled.

In the foregoing Detailed Description, various features are grouped together in a single embodiment for the purpose of streamlining the disclosure. This method of disclosure is not to be interpreted as reflecting an intention that the disclosed embodiments of the present disclosure have to use more features than are expressly recited in each claim. Rather, as the following claims reflect, inventive subject matter lies in less than all features of a single disclosed embodiment. Thus, the following claims are hereby incorporated into the Detailed Description, with each claim standing on its own as a separate embodiment.

What is claimed is:

1. An apparatus, comprising:
a data bus coupled to an array of memory cells and configured to receive first data;
a processing unit (PU) coupled to the data bus and configured to:
receive the first data from the data bus;
perform a plurality of operations utilizing the first data to generate second data; and
provide the second data to the data bus to store the second data in the array of memory cells.

2. The apparatus of claim 1, wherein the data bus in an input data bus.

3. The apparatus of claim 2, wherein the input data bus is configured to receive the first data from a host.

4. The apparatus of claim 2, wherein the input data bus is further configured to provide the second data to the array of memory cells.

5. The apparatus of claim 1, wherein the data bus is an output data bus.

6. The apparatus of claim 5, wherein the output data bus is configured to receive the first data from the array of memory cells.

7. The apparatus of claim 5, wherein the output data bus is further configured to provide the second data to data pins of the apparatus.

8. The apparatus of claim 5, wherein the output data bus is further configured to provide the second data to the array of memory cells via an input data bus of the apparatus.

9. An apparatus, comprising:
a first data bus coupled to an array of memory cells;
a second data bus coupled to the array of memory cells;
a processing unit (PU) coupled to the first data bus and the second data bus and configured to:
receive first data from the first data bus and not the second data bus; and
perform a plurality of operations utilizing the first data to generate second data; and
provide the second data to the second data bus and not the first data bus.

10. The apparatus of claim 9, wherein the first data bus is an input data bus and the second data bus is an output data bus.

11. The apparatus of claim 10, wherein the input data bus is configured to provide the first data to the array of memory cells or the PU and the output data bus is configured to provide the second data received from the PU or different data received from the array of memory cells to data pins.

12. The apparatus of claim 9, wherein the first data bus is an output data bus and the second data bus is an input data bus.

13. The apparatus of claim 12, wherein the input data bus is configured to provide the second data or different data to the array of memory cells and the output data bus is configured to provide first data received from the array of memory cells to data pins or the PU.

14. The apparatus of claim 9, further comprising a first control circuitry and a second control circuitry configured to couple the first data bus and the second data bus to the PU.

15. The apparatus of claim 14, wherein:
the first control circuitry couples the first data bus to the PU and comprises a 1:2 multiplexor (MUX) configured to:
receive the first data from the array of memory cells; and
provide the first data to the PU or data pins; and
the second control circuitry couples the second data bus to the PU and comprises a 2:1 MUX configured to:
receive the second data from the PU or different data from the data pins; and
provide the different data or the second data to the array.

16. The apparatus of claim 14, wherein:
the first control circuitry couples the first data bus to the PU and comprises a 1:2 multiplexor (MUX) configured to:
receive the first data from data pins; and
provide the first data to the PU or the array; and
the second control circuitry coupled the second data bus to the PU and comprises a 2:1 MUX configured to:
receive the second data from the PU or different data from the array; and
provide the second data or the different data to the data pins.

17. The apparatus of claim 14, wherein the PU further comprises a controller to configure the first control circuitry and the second control circuitry.

18. A method, comprising:
receiving, by a processing unit (PU), first data from an array of memory cells via a first data bus;
performing, by the PU, a plurality of operations on the first data to generate second data;
providing, by the PU, the second data to the first data bus;
providing, by the first data bus, the second data to a second data bus; and
providing, by the second data bus, the second data to the array to store the second data in the array.

19. The method of claim 18, further comprising:
receiving, by the PU, an indication that the first data is available on the first data bus; and
configuring a first control circuitry to provide the first data to the PU from the first data bus;
receiving, by the PU, a different indication that the first data bus is available; and
configuring the second control circuitry to provide the second data to first data bus.

20. The method of claim 19, further comprising:
configuring the first control circuitry to provide data to the data pins responsive to the PU receiving the first data from the array; and
configuring the second control circuitry to provide data to the data pins responsive to the array of memory cells receiving the second data.
